(19) United States
(12) Patent Application Publication
(10) Pub. No.: US 2018/0240166 A1
(43) Pub. Date: Aug. 23, 2018

(54) VIRTUAL REALITY SOUVENIR AND DISTRIBUTION SYSTEM

(71) Applicant: PANASONIC INTELLECTUAL PROPERTY MANAGEMENT CO., LTD., Osaka (JP)

(72) Inventors: John CRONIN, Bonita Springs, FL (US); Michael Glynn D'ANDREA, Burlington, VT (US); Seth Melvin CRONIN, Essex Junction, VT (US); Kota MORISAKI, Arlington, VA (US)

(73) Assignee: PANASONIC INTELLECTUAL PROPERTY MANAGEMENT CO., LTD., Osaka (JP)

(21) Appl. No.: 15/438,101

(22) Filed: Feb. 21, 2017

(51) Int. Cl. G06Q 30/06; H04N 5/247; H04N 5/232

(52) U.S. Cl. CPC G06Q 30/0601; H04N 5/23203; H04N 5/247

(57) ABSTRACT

A method for distributing a virtual reality souvenir includes acquiring, using a processor of a computer, audio and video data via one or more recording devices, compiling the acquired audio and video data into a virtual reality file, acquiring user identifying information corresponding to the acquired audio and video data, wherein the user identifying information includes at least one of user information, attraction information, recording time, and ride seat number, storing the virtual reality file and the corresponding identifying information into a database, retrieving, using the processor, the virtual reality file and the corresponding user identifying information from the database, and transmitting, using the processor, to a user device the retrieved virtual reality file and the corresponding identifying information via at least one of a digital distribution system and a physical souvenir distribution system.

### BACKGROUND

### 1. Field of the Disclosure

The present disclosure relates to the field of electronic souvenirs. More particularly, the present disclosure relates to a virtual reality souvenir and distribution system.

### 2. Background Information

Operators of resorts, theme parks, hotels, museums, casinos, and other venues maintain constant efforts to improve profits while maximizing the user experience. Once such way is to provide for purchase a photo of an amusement park ride guest at the end of the guest's experience. Such photo is typically printed out with a frame with the name of the amusement park, or may be provided by a number of other ways, such as in a keychain or CD-ROM. One drawback to providing such a photo is that it is a static memento fixed in time, and does not allow the guest to thoroughly relive the experience of enjoying an amusement park ride. Therefore, there is a need to improve a guest's experience while maximizing amusement park profit opportunities.

### SUMMARY OF THE DISCLOSURE

Virtual reality (VR) experiences can closely mimic the experience of riding actual roller coasters, cutting into market share. This idea uses 3D modeling and 3D vision technology to record a 3D model of a group of guests on a ride at a theme park to be sold as a digital souvenir. The 3D souvenir includes the audio from the guest's experience on the ride, along with 3D video reconstruction of friends in adjacent seats and other riders. The 3D souvenir can be replayed by guests at home using their home VR viewer, allowing guests to re-experience the ride in a home setting. This becomes a platform technology for souvenirs, and money may be made by charging for the VR file/souvenir.

In some aspects, video and audio souvenirs of a ride are made available for sale to guests of a resort or other venue. Cameras (guest facing and forward facing) may be mounted on the ride to record video of the ride experience. Directional microphones may be positioned at each row of seats to capture the audio of specific guests on the ride. The audio of specific guests is correlated with the seats guests sit in, and integrated with the video souvenir. At the end of the ride, each guest is provided the option to purchase a digital copy of the ride with their own personalized audio. Money may be made by charging for the VR file/souvenir.

Unique and personalized souvenirs that capture a real experience with friends and family are provided. The VR file/souvenir can also allow users to share the experience with those too young/not healthy enough/too distant to experience the real thing.

A non-limiting feature of the disclosure provides a method for distributing a virtual reality souvenir includes acquiring, using a processor of a computer, audio and video data via one or more recording devices, compiling the acquired audio and video data into a virtual reality file, acquiring user identifying information corresponding to the acquired audio and video data, wherein the user identifying information includes at least one of user information, attraction information, recording time, and ride seat number, storing the virtual reality file and the corresponding identifying information into a database, retrieving, using the processor, the virtual reality file and the corresponding user identifying information from the database, and transmitting, using the processor, to a user device the retrieved virtual reality file and the corresponding identifying information via at least one of a digital distribution system and a physical souvenir distribution system.

The retrieving of the virtual reality file and the corresponding user identifying information may be based on a user's identity. Further, the user's identity may be based on at least one of the user's identification code, name and biometric data. The biometric data may include the user's fingerprint, eye, face and hand.

The acquiring of the user identifying information may further include at least one of a user wearing the one or more recording devices, and a user holding the one or more recording devices.

Also provided is a system for distributing a virtual reality souvenir, the system including a plurality of cameras configured to capture a plurality of images, a plurality of microphones configured to capture a plurality of sounds, wherein the plurality of cameras and plurality of microphones are mounted to an attraction, a memory configured to store the captured images and sounds, a compiler configured compile the stored images and sounds into a virtual reality file, and a transmitter configured to transmit the compiled virtual reality file to an external device.

At least one camera of the plurality of cameras may be configured to capture an image of a user of the attraction, and at least one microphone of the plurality of cameras may be configured to capture a sound of the user.

The memory may be further configured to store identifying information of the user, and the transmitter may be further configured to transmit the compiled virtual reality file to the external device based on the identifying information. Also, the identifying information may be captured by at least one camera of the plurality of cameras via at least one of a user's body part and a scannable code. At least another camera of the plurality of cameras may be configured to capture an image of another user located adjacent to the user of the attraction.

The memory may be further configured to store identifying information of a user, and the transmitter may be further configured to transmit the compiled virtual reality file to the external device based on the identifying information. Also provided may be a scanner configured to scan the identifying information, wherein the transmitter may be further configured to transmit the compiled virtual reality file to the external device upon scanning of the identifying information.

The external device may be at least one of a stationary computer, a mobile computer, a personal computer, a laptop computer, a tablet computer, a wireless smartphone, a personal digital assistant, a global positioning satellite device, a virtual reality system, an augmented reality system, and a kiosk. Also, the compiler may be further configured to add to the virtual reality file an image of a user who was not captured by a camera of the plurality of cameras.

Also provided may be a kiosk for distributing a virtual reality souvenir, including a receiver configured to receive from a database (a) a virtual reality file of audio and video images captured at an attraction, and (b) user identifying information associating a user with the virtual reality file, and a transmitter configured to transmit the virtual reality file to an external device.

The kiosk may further include a point-of-sale system configured to accept at least one of electronic and cash payment for the virtual reality file. Also, the transmitter may be further configured to wirelessly transmit the virtual reality file to a user device. The transmitter may be further configured to write the virtual reality file to a tangible storage medium. The kiosk may also include a display configured to display the images of the virtual reality file.

Also provided may be a tangible non-transitory computer readable storage medium that stores a computer program, the computer program, when executed by a processor, causing a computer apparatus to perform the above-described method.

Other exemplary embodiments and advantages of the present disclosure may be ascertained by reviewing the present disclosure and the accompanying drawings, and the above description should not be considered to limit the scope of the present invention.

### BRIEF DESCRIPTION OF THE DRAWINGS

The novel features which are characteristic of the systems, both as to structure and method of operation thereof, together with further objects and advantages thereof, will be understood from the following description, considered in connection with the accompanying drawings, in which a presently preferred embodiment of the system is illustrated by way of example. It is to be expressly understood, however, that the drawings are for the purpose of illustration and description only, and they are not intended as a definition of the limits of the system. For a more complete understanding of the disclosure, as well as other aims and further features thereof, reference may be had to the following detailed description of the disclosure in conjunction with the following exemplary and non-limiting drawings wherein:

FIG. 1 shows an exemplary general computer system that includes a set of instructions for a method of providing a virtual reality souvenir and distribution system, in accordance with an aspect of the disclosure;

FIG. 2 shows an exemplary attraction in the form of a vehicle for use with a method of providing a virtual reality souvenir and distribution system, in accordance with an aspect of the disclosure;

FIG. 3 shows a schematic view of virtual reality souvenir and distribution system, in accordance with an aspect of the disclosure;

FIG. 4 shows an exemplary kiosk for use with a method of providing a virtual reality souvenir and distribution system, in accordance with an aspect of the disclosure;

FIG. 5 shows a flowchart of a method of providing a virtual reality souvenir and distribution system, in accordance with an aspect of the disclosure

FIG. 6A shows an exemplary schematic plan view of the attraction of FIG. 2;

FIG. 6B shows another exemplary schematic plan view of the attraction of FIG. 2;

FIG. 6C shows yet another exemplary schematic plan view of the attraction of FIG. 2;

FIG. 7 shows a flowchart of a system by which a user can order a VR-compatible file; and

FIG. 8 shows a flowchart showing the process by which a sample video of FIG. 7 is created.

### DETAILED DESCRIPTION

In view of the foregoing, the present disclosure, through one or more of its various aspects, embodiments and/or specific features or sub-components, is thus intended to bring out one or more of the advantages as specifically noted below.

In the following description, the various embodiments of the present disclosure will be described with respect to the enclosed drawings. As required, detailed embodiments of the present disclosure are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, the description is taken with the drawings making apparent to those skilled in the art how the forms of the present disclosure may be embodied in practice.

Methods described herein are illustrative examples, and as such are not intended to require or imply that any particular process of any embodiment be performed in the order presented. Words such as “thereafter,” “then,” “next,” etc. are not intended to limit the order of the processes, and these words are instead used to guide the reader through the description of the methods. Further, as used herein, the singular forms “a,” “an,” and “the” include the plural reference unless the context clearly dictates otherwise. For example, reference to “a magnetic material” would also mean that mixtures of one or more magnetic materials can be present unless specifically excluded.

Except where otherwise indicated, all numbers expressing quantities used in the specification and claims are to be understood as being modified in all instances by the term “about.” Accordingly, unless indicated to the contrary, the numerical parameters set forth in the specification and claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

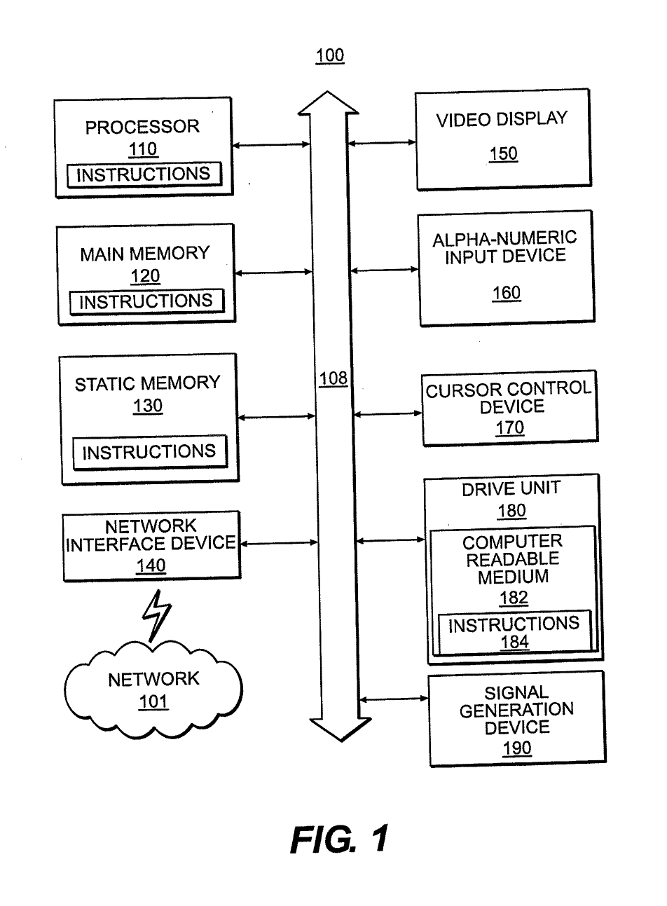

Referring to the figures wherein like characters represent like elements, FIG. 1 is an illustrative embodiment of a general computer system, on which a method of providing a virtual reality souvenir and distribution system can be implemented, and which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system 100 may operate in the capacity of a server or as a client user computer in a server-client user network environment, or as a peer computer system in a peer-to-peer (or distributed) network environment. The computer system 100 can also be implemented as or incorporated into various devices, such as a stationary computer, a mobile computer, a personal computer (PC), a laptop computer, a tablet computer, a wireless smartphone, a set-top box (STB), a personal digital assistant (PDA), a global positioning satellite (GPS) device, a communications device, a control system, a camera, a web appliance, a network router, switch or bridge, virtual reality (VR) system, augmented reality (AR) system, a kiosk or any other machine capable of executing a set of instructions (sequential or otherwise) that specify actions to be taken by that machine. The computer system 100 can be incorporated as or in a particular device that in turn is in an integrated system that includes additional devices. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 includes a processor 110. A processor for a computer system 100 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A processor is an article of manufacture and/or a machine component. A processor for a computer system 100 is configured to execute software instructions in order to perform functions as described in the various embodiments herein. A processor for a computer system 100 may be a general purpose processor or may be part of an application specific integrated circuit (ASIC). A processor for a computer system 100 may also be a microprocessor, a microcomputer, a processor chip, a controller, a microcontroller, a digital signal processor (DSP), a state machine, or a programmable logic device. A processor for a computer system 100 may also be a logical circuit, including a programmable gate array (PGA) such as a field programmable gate array (FPGA), or another type of circuit that includes discrete gate and/or transistor logic. A processor for a computer system 100 may be a central processing unit (CPU), a graphics processing unit (GPU), or both. Additionally, any processor described herein may include multiple processors, parallel processors, or both. Multiple processors may be included in, or coupled to, a single device or multiple devices.

Moreover, the computer system 100 includes a main memory 120 and a static memory 130 that can communicate with each other via a bus 108. Memories described herein are tangible storage mediums that can store data and executable instructions, and are non-transitory during the time instructions are stored therein. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. A memory described herein is an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a removable disk, tape, compact disk read only memory (CD-ROM), digital versatile disk (DVD), floppy disk, Blu-ray disk, or any other form of storage medium known in the art. Memories may be volatile or non-volatile, secure and/or encrypted, unsecure and/or unencrypted.

As shown, the computer system 100 may further include a video display 150, such as a liquid crystal display (LCD), an organic light emitting diode (OLED), a flat panel display, a solid state display, or a cathode ray tube (CRT). Additionally, the computer system 100 may include an input device 160, such as a keyboard/virtual keyboard or touch-sensitive input screen or speech input with speech recognition, and a cursor control device 170, such as a mouse or touch-sensitive input screen, pad, augmented reality input device, visual input device, video input device, 3D input device, human eye position input device, haptic input device, body tracking device, acoustic tracking device, or a data glove. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. Sets of instructions 184 can be read from the computer-readable medium 182. Further, the instructions 184, when executed by a processor, can be used to perform one or more of the methods and processes as described herein. In a particular embodiment, the instructions 184 may reside completely, or at least partially, within the main memory 120, the static memory 130, and/or within the processor 110 during execution by the computer system 100.

In an alternative embodiment, dedicated hardware implementations, such as application-specific integrated circuits (ASICs), programmable logic arrays and other hardware components, can be constructed to implement one or more of the methods described herein. One or more embodiments described herein may implement functions using two or more specific interconnected hardware modules or devices with related control and data signals that can be communicated between and through the modules. Accordingly, the present disclosure encompasses software, firmware, and hardware implementations. Nothing in the present application should be interpreted as being implemented or implementable solely with software and not hardware such as a tangible non-transitory processor and/or memory.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionality as described herein, and a processor described herein may be used to support a virtual processing environment.

The present disclosure contemplates a computer-readable medium 182 that includes instructions 184 or receives and executes instructions 184 responsive to a propagated signal; so that a device connected to a network 101 can communicate voice, video or data over the network 101 via any of, for example, NFC, wired, RF, RFID, AirDrop, WiFi, Bluetooth, Bluetooth Low Energy (BLE), Active Bat, near field communication, Zigbee, ANT, and Foundation Fieldbus H1. Further, the instructions 184 may be transmitted or received over the network 101 via the network interface device 140.

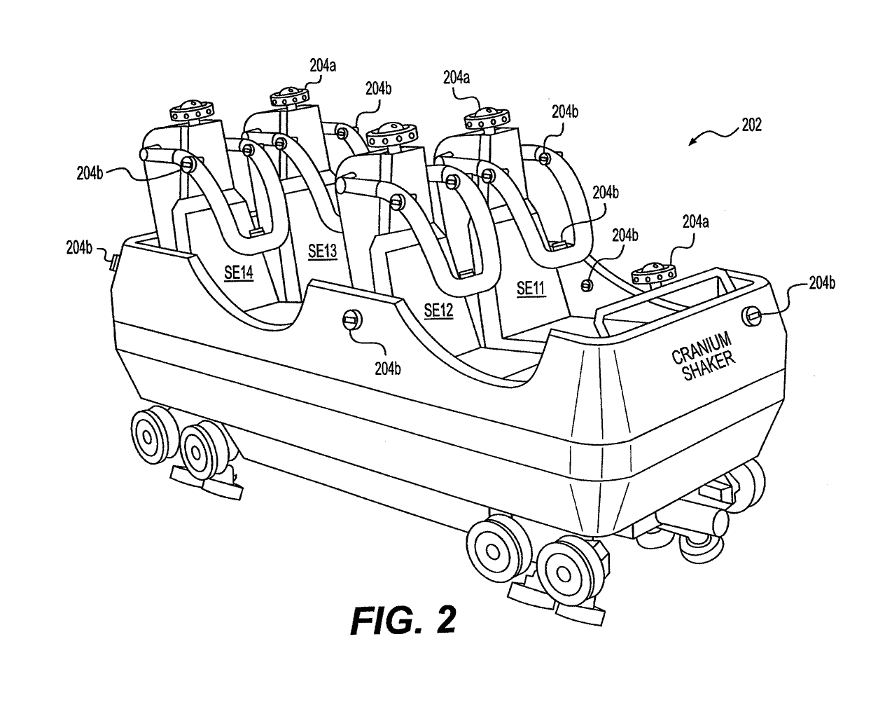

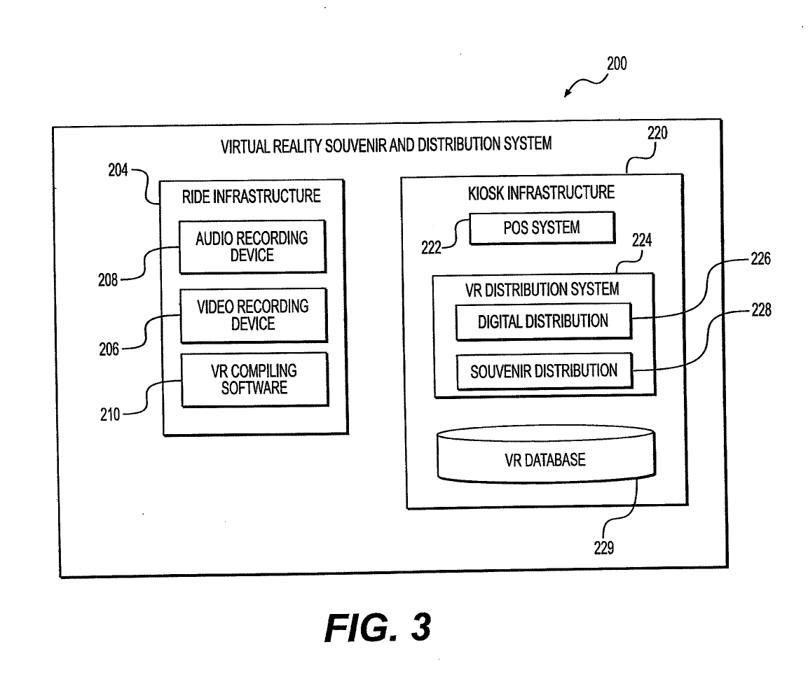

FIG. 2 shows an attraction in the form of a vehicle 202 for use with a virtual reality souvenir and distribution system 200. The term “attraction,” as used herein, may refer to anything (mobile or stationary) with which a guest interacts, including but not limited to a theater, roller coaster or other theme park ride or vehicle, dining establishment and the like. The vehicle 202 is part of ride infrastructure 204, shown in FIG. 3.

As used herein, the term “venue” includes any place or event where images may be captured, such as a resort, hotel, travel destination, theme park, amusement park, hiking park, casino, golf course, museum, campus, or travel destination, for example. In a non-limiting example, venue 200 may refer to a resort. In an alternative non-limiting example, venue 200 may refer to a hotel and an amusement park. Specifically, venue 200 encompasses any facility, location, or place, providing physical boundaries to fulfill one or more objectives of the present invention. Other types of venues will be apparent to those of ordinary skill in the art. Exemplary venues include one or more attractions which may be visited by one or more guests.

The term “operator,” as used herein, may refer to any entity acting on behalf of the venue who may affect the satisfaction of its guests. For example, an operator may be a travel management company, or alternatively, an operator may be a government entity. A non-exhaustive and exemplary list of operators may include both nonprofit and for-profit entities. In addition to travel management companies, for-profit operators may include entities engaged in earning profits at amusement parks, casinos, museums, resorts, hotels, or other venues. Also, in addition to government entities, nonprofit operators may include educational universities or arts organizations, for example.

Any venue, regardless of the type of venue, may have a plurality or guests (2) present at a time. As used herein, the term “guest” is meant to include any type of person or group at any type of venue. Accordingly, the term “guest” should not be read to require a particular relationship between the person and the venue, such as one where money is exchanged by way of example only. Thus, terms like “visitor,” “person,” “guest,” “rider,” “user,” and “patron” will be used interchangeably herein. In addition, a guest may include a group of people who are at the venue, where such people of the group have some sort of relation to each other. For instance, where a family of four goes to an amusement park, the entire family may be collectively regarded as a guest of that venue, as may each individual person within the family of four. As another merely illustrative example, where a school class goes to a zoo, the entire class may be collectively regarded as a guest of that venue, as well as each member of the class. A guest to a venue may be a paying guest, in which the guest pays to enter the venue, or a non-paying guest.

FIG. 3 is a schematic view of a virtual reality souvenir and distribution system 200, in which a method for distributing a virtual reality souvenir may be implemented. The method, and various embodiments thereof, may be implemented locally within a predetermined device. On the other hand, some or all of the steps of the method may be implemented on an external network 101. The virtual reality souvenir and distribution system 200 is connected to the computer system 100, shown in FIG. 1.

As shown in FIG. 2, the vehicle 202 includes a plurality of cameras 204a and/or 204b mounted thereto. Each camera 204a, 204b is connected one or more video recording devices 206 (for example, a digital video recorder (DVR)) connected to the computer system 100, and is further connected to one or more audio recording devices 208 (for example, a digital voice recorder) connected to the computer system. Microphones may be directional microphones, which may be integral to the camera 204a, 204b or may be separately provided. The microphones may be positioned in each row of the vehicle 202. Each camera 204a, 204b may include its own video recording device 206 and audio recording device 208, or video recording devices and audio recording devices may be shared among other cameras 204a, 204b over network 101. It is noted that audio recording device 208 may record audio in stereo, mono, surround or any other suitable format.

Camera 204a is shown as a purpose-built VR camera assembly capable of recording video, with a plurality of cameras aimed in a surrounding 360° angle (including up/down). It is noted that in addition or alternatively, one or more video cameras 204b may strategically mounted about the vehicle 202. The cameras 204a, 204b are configured to provide views about the vehicle in substantially all outward directions from the vehicle, so as to simulate a vehicle rider's point of view (POV), and may be further configured to provide views inside the vehicle. In this way, audio and video of other riders can be captured, thereby personalizing the experience for each rider, e.g., so that one rider can hear and watch the reactions of his/her companion(s) next to him/her on the ride. Camera 204b may be any type of suitable camera, such as a VR camera, high-definition (HD) camera and/or a 3D camera, and/or even an off-the-rack video camera or smartphone camera, depending on the application.

Although vehicle 202 shows cameras 204a, 204b which capture, inter alia, video from the POV of each seat of a ride (so that audio and video may be captured from the POV of each seat of the ride), it is noted that in alternative aspect only a select number of seats may be fitted with cameras 204a, 204b (e.g., not all seats). It is also noted that although vehicle 202 shows cameras 204a, 204b installed thereon, in addition or alternatively, cameras may be held by a rider in the form of e.g., headgear or headwear. It is also noted that other cameras 204a, 204b may be positioned elsewhere in the venue to enhance the rider experience.

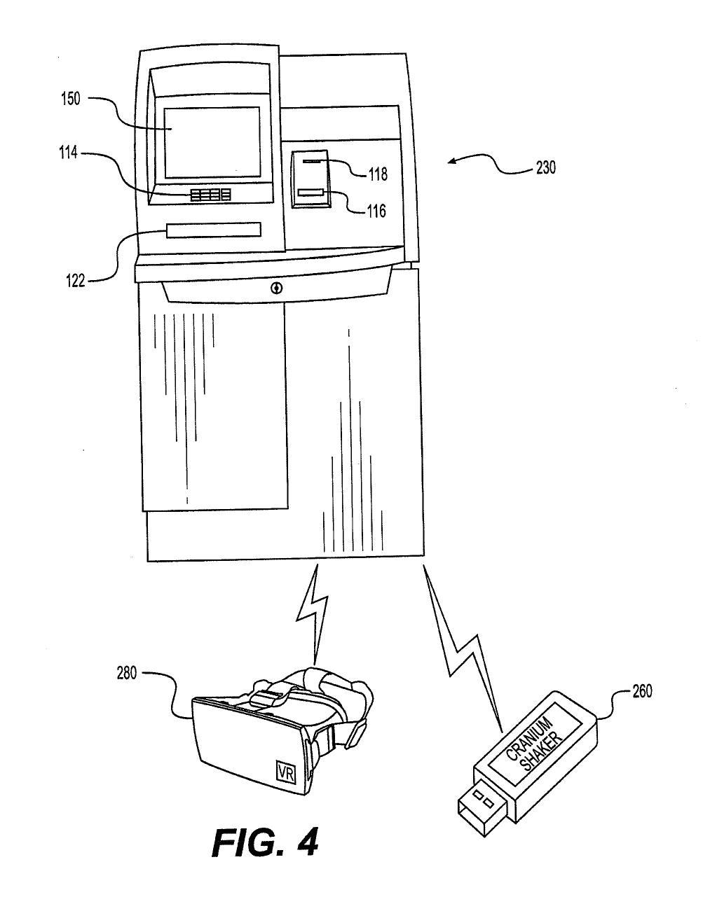

During operation of the attraction, video and audio respectively recorded by video recording device 206 and audio recording devices 208 are compiled into a VR-compatible file including ride data using VR compiling software 210. The compiled VR-compatible file may then be opened and viewed in a VR viewer 280 (shown in FIG. 4) as an immersive virtual reality experience. Suitable examples of VR viewers include goggles, headsets, glasses as well as immersive viewing rooms and booths. It is noted that although FIG. 3 shows the VR compiling software 210 as part of the ride infrastructure 204, the VR compiling software may be at any suitable location connected to the computer system 100, including by network 101.

It is noted that additionally or alternatively to capturing audio and video of a rider, it is noted that the VR compiling software 201 can also be configured to include audio and/or video data not captured on the same ride as the rider. For example, video (and possibly audio) of a user who was not on the ride may be provided to the compiling software 201 to create a unique ride data file who was not captured by cameras 204a, 204b during the ride. For example, from the comfort of his/her home the user may upload a file to the VR compiling software 201 to create a unique ride data file providing a VR experience showing the user on the ride, when in fact the user was never on the ride, thereby giving the impression to the individual viewing and experiencing the VR ride data file that the user was actually on the ride. In another aspect, in a situation where two riders were not able to ride an attraction together, each rider's individual audio and video data may be provided to the VR compiling software 201 to render an appearance that both riders were riding the attraction together. Multiple viewers 280 may be linked together (e. g, via the computer system) to allow multiple users to share the same ride experience from their own or a shared POV.

It is also noted that audio and video data captured by other cameras 204a, 204b positioned elsewhere in the venue may be provided to the VR compiling software 201 to create a VR data file which includes a VR experience in addition to the VR experience of the ride or attraction itself (e.g., strolling through the venue, dining at a restaurant, and the like). These other cameras 204a, 204b also allow the viewing user to toggle between different views when viewing the VR data file (for example, toggling between the user's POV and a view of the attraction from the ground).

Once the VR-compatible file is created, it is associated with identifying information including but not limited to the identification (also referred to as a tag, or guest ID) of the rider (including but not limited to date, time, vehicle, seat, camera, file, name, code, rider size, address, contact information, venue loyalty code), vehicle seat number, attraction, location, time recorded and date recorded. Rider/user identification may be made by a variety of ways, for example, through a scannable code (including but not limited to a barcode, QR code or RFID device) worn by or otherwise in the rider's possession, by providing the rider's name, username/handle and/or unique identification code (which may correspond to a rider's venue loyalty code), and/or by verifying the rider using biometric data. Such biometric data may include data scanned from the rider's fingerprint(s), eye, face and hand, by one or more scanners 240 strategically positioned throughout the venue. In the case of facial biometric data, such data may be captured by the same cameras 204a, 204b used to create the VR-compatible file, and additionally or alternatively may be different cameras positioned elsewhere in the venue.

The VR-compatible file includes ride data and data associated with identifying information, and is stored in a VR database 229 for retrieval based on the identifying information. The VR-compatible file is then made available for purchase or other acquisition by the operator. In one aspect, the VR-compatible file is transmitted (either wirelessly or by wire) to one or more external devices such as a kiosk 230, which is part of the computer system 100. Other examples of external devices include a portable solid-state hard drive such as a flash or USB drive 260, a stationary computer, a mobile computer, a personal computer, a laptop computer, a tablet computer, a wireless smartphone, a personal digital assistant, a global positioning satellite device, a virtual reality system and an augmented reality system.

The kiosk 230 may be located at the exit of the attraction and/or may be located elsewhere in the venue. The kiosk may include a receiver 140 for receiving the VR-compatible file. Although FIG. 3 shows the VR database 229 as part of the kiosk 230, it is noted that the VR database may alternatively or additionally be employed in any suitable configuration with respect to the computer system 100 (including but not limited to the main memory 120).

The kiosk 230 also includes kiosk infrastructure 220 such as a point-of-sale (POS) system 222, which can accept payment from a guest in the form of cash, credit/debit card, PIN code, mobile device payment (e.g. via near field communication (NFC) antenna). The guest may interact with the kiosk 230 via any combination of a display 150, push buttons 114, card acceptance slot 116, coin acceptance slot 118 and/or bill acceptance slot 122. Alternatively, the POS system 222 (as well as any components of the display 150, push buttons 114, card acceptance slot 116, coin acceptance slot 118 and/or bill acceptance slot 122) may be omitted in favor a guest directly interfacing with the kiosk 230 using his/her mobile device over the network 101. It is also noted that an aspect of the disclosure may omit the kiosk 230 altogether in favor of a system where the computer system directly transmits the VR-compatible file to the user from a central location. It is further noted that the kiosk 230 may be operated by a venue employee or the guest.

The kiosk infrastructure 220 also includes a VR distribution system 224 which allows the VR-compatible file to be transmitted/distributed to a user electronically via a digital distribution system 226 or in the form of a physical souvenir 260 via souvenir distribution system 228. For example, the digital distribution system 226 may electronically transmit the VR-compatible file via e-mail or other means (such as NFC, wired, RF, RFID, AirDrop, WiFi, Bluetooth, Bluetooth Low Energy (BLE), Active Bat, near field communication, Zigbee, ANT, and Foundation Fieldbus H1). As another example, the souvenir distribution system 228 creates and dispenses a physical souvenir 260 containing the VR-compatible file by writing it to the physical souvenir 260, which may be in the form of a portable solid-state hard drive such as a flash or USB drive, which the user takes possession of at the kiosk 230 or elsewhere in the venue (e.g., from an employee, from a different kiosk or from a vending machine).

As shown in FIG. 4, the physical souvenir 260 may also on the outside display the name of the attraction (e.g., Cranium Shaker) where the video and audio were captured. It is also noted that additionally or alternatively to the kiosk 230 dispensing the souvenir 260, a user may use a single physical souvenir 260 throughout the venue, upon which VR-compatible files of a plurality of rides may be written (e.g., the user may insert the physical souvenir in the kiosk 230 associated with each attraction, where the kiosk writes a respective VR-compatible file to the souvenir 260, which also works with different attractions throughout the venue). Once the VR-compatible file is in the user's possession, the user may open and view the VR-compatible file on his/her VR viewer 280. As shown in FIG. 4 it is also noted a VR viewer 280 may be provided at the kiosk 230 so that the rider can open and experience his/her VR-compatible file prior to purchase. Additionally or alternatively, the VR-compatible file may be opened and experienced on display 150 (either in virtual reality or not).

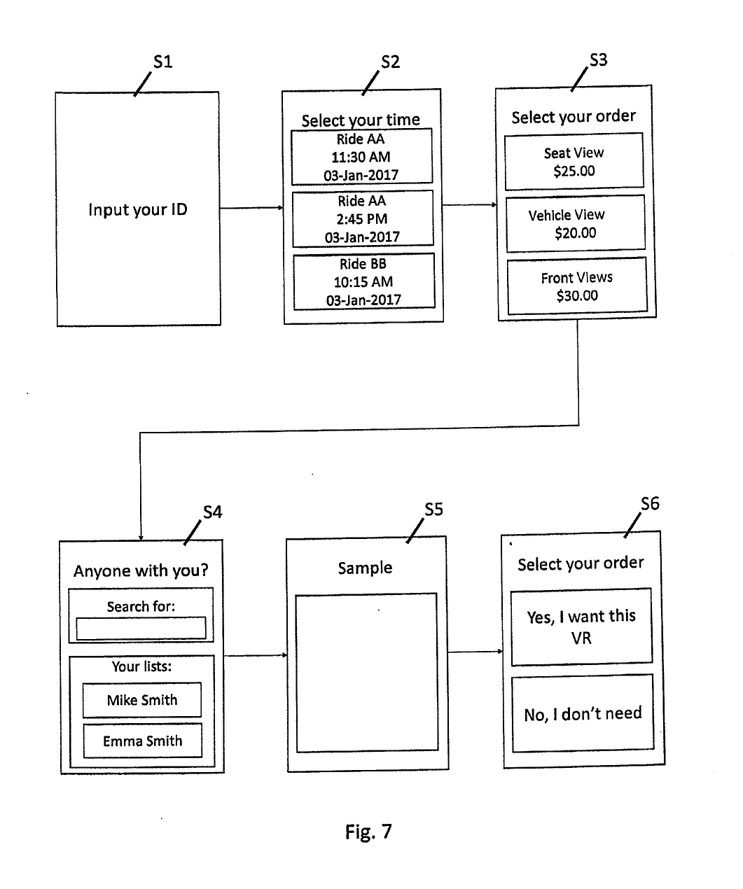

FIG. 7 shows flowchart of a system by which a user can order the VR-compatible file. In Step S1 the user the rider/user identification is provided to the external device such as a kiosk 230. In a situation where there is more than one ride associated with the rider/user identification, at Step S2 the user is prompted to select the desired ride based on ride name and/or time of ride. At Step S3 the user is prompted to select the type of VR-compatible file (e.g., seat view, vehicle view and/or front view), further described below.

At Step S4 the user is prompted to select members of his/her party to be included in the VR-compatible file, including providing the user with a rider search option. This prompt may be generated in situations, where e.g., the rider pre-registered with other individuals in association with the ride and/or venue, or the computer system 100 determines that the listed riders got on the same ride together with the user, and in the case of a solo visitor/rider, Step S4 may be skipped. At Step S5 the user is shown a sample video to assist him/her in deciding whether to purchase the VR-compatible file. Once the sample video is shown, at Step S6 the user is prompted to input whether or not he/she wishes to purchase the VR-compatible file.

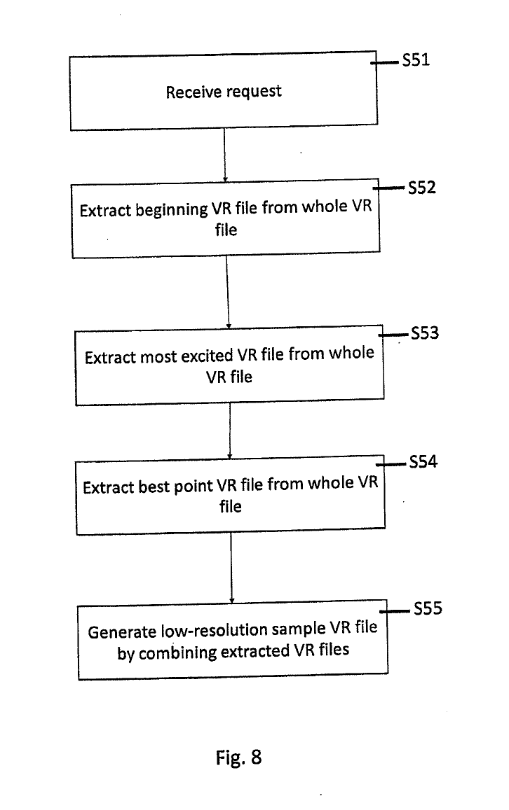

FIG. 8 is a flowchart showing the process by which the sample video of Step S5 is created. In Step S51 the request for a sample video is received by the computer system 100. At Step S52 VR data showing the beginning of the ride (i.e., when the rider first begins to experience the ride) is extracted from the VR database 229. In Step S53 VR data showing the point of the ride where the rider is most excited is extracted from the VR database 229. This data is extracted based on, e.g., analysis of the rider's face captured by the cameras 204a, 204b during the ride and/or analysis of the rider's voice captured by the microphone during the ride (e.g., the computer system 100 may select this data based on a rider's eyes being wide and/or a user's scream volume). At Step S54 VR data showing the point of the ride where the rider is most happiest (or best emotion) is extracted from the VR database 229. This data is extracted based on, e.g., analysis of the rider's face captured by the cameras 204a, 204b during the ride and/or analysis of the rider's voice captured by the microphone during the ride (e.g., the computer system 100 may select this data based on size of a rider's smile and/or a user's laughter volume). At Step S55 a low-resolution sample VR file is then generated based on the VR data extracted in Steps S52, S53 and/or S54. It is noted that it is appreciated that in an alternative aspect of the disclosure, Steps S52, S53 and/or S54 may be omitted.

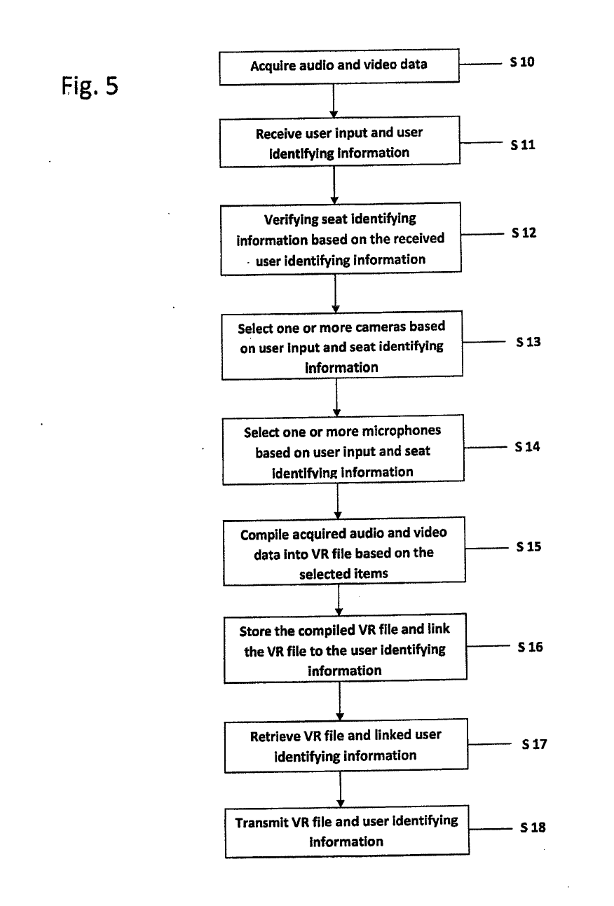

A method for distributing a virtual reality souvenir is described with reference to FIG. 5. In step S10, in conjunction with the computer system 100, audio and video data is respectively acquired by one or more microphones and one or more cameras 204a and/or 204b, which is then stored in a memory. In step S11, the computer system 100 receives user input and user identifying information. In step S12, the computer system 100 verifies seat identifying information based on the received user identifying information. At Step S13 the computer system 100 selects one or more cameras 204a, 204b based on user input and seat identifying information. At Step S14 the computer system selects one or more microphones based on the user input and seat identifying information.

At Step S15 the computer system 100 compiles the acquired audio and video data into a VR-compatible file based on the data selected in Steps S13-S14. In step S16, the computer system 100 stores the YR-compatible file and linked corresponding user/rider identifying information in the database 229. In step S17, the computer system retrieves the VR-compatible file including the corresponding user/rider identifying information from the database 229. In step S18, the computer system 100 transmits (either wirelessly or by wire) to one or more external devices (such as a kiosk 230, a user's smartphone, a user's PC and the like) the VR-compatible file including the corresponding identifying information, via at least one of the digital distribution system 226 and a physical souvenir distribution system 228.

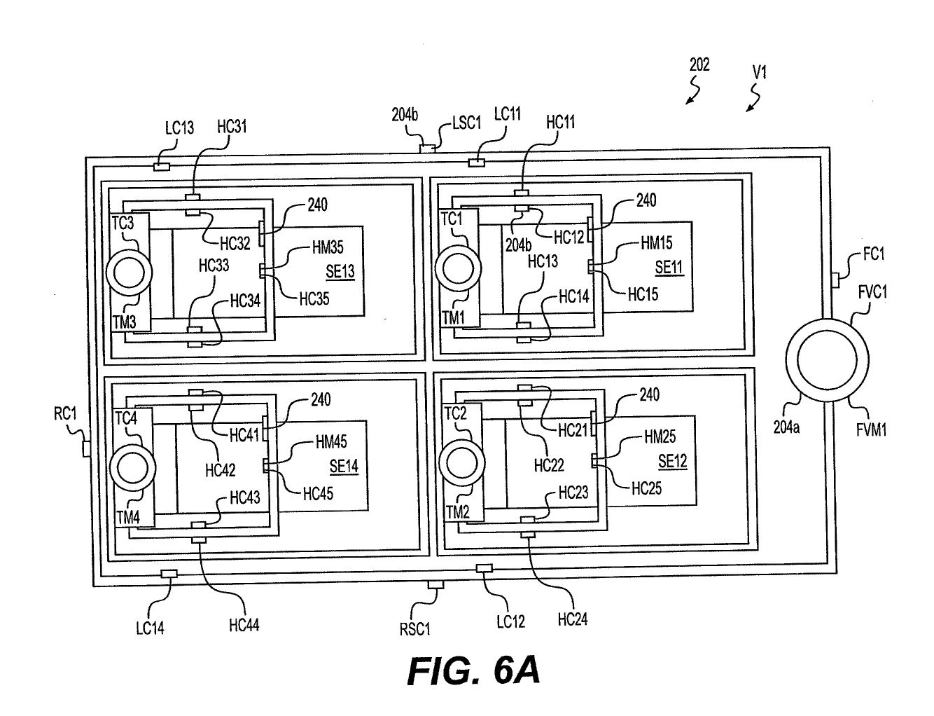

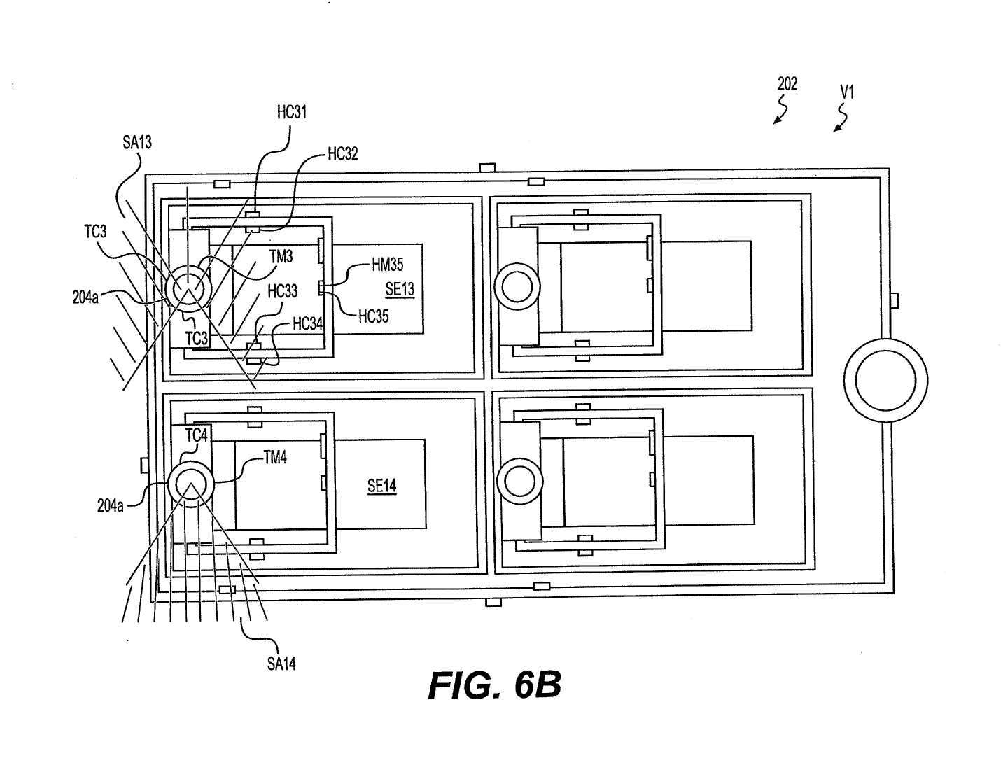

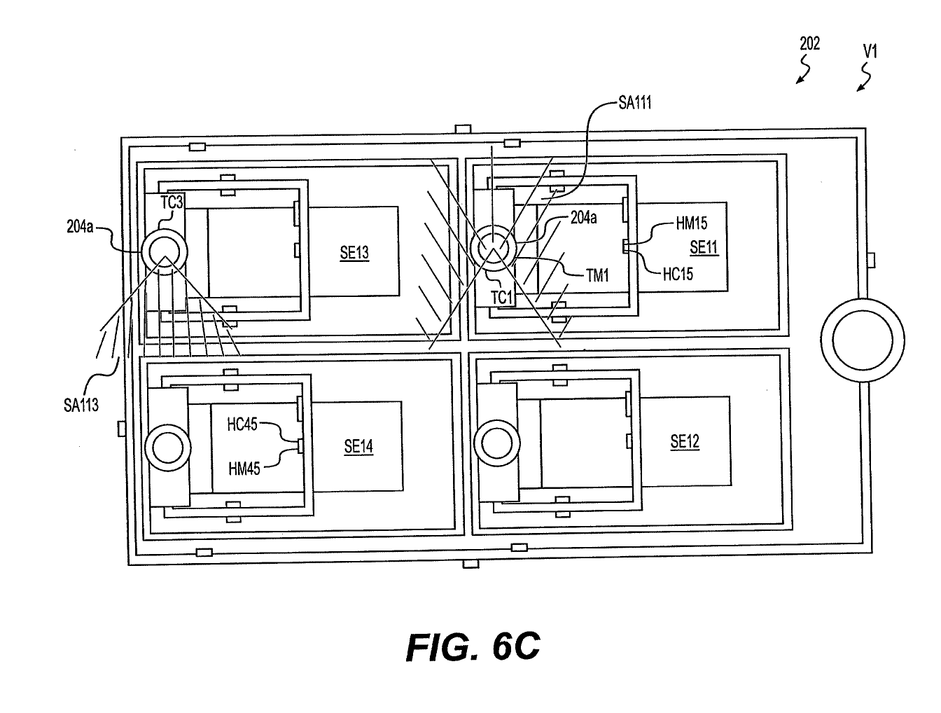

Further explanation of the creation of the VR-compatible file will be explained. FIG. 6A is a plan view of vehicle 202 identifying the cameras 204a, 204b by location on the vehicle (identified as V1 or CA1). For example, shown are top cameras TC1-TC3 and front view camera FVC1, all of all of which may be implemented as camera 204a. Also shown are left side camera LSC1, right side camera RSC1, front camera FC1, rear camera RC1, line camera L11-LC14, harness camera HC11-HC44, all of which may be implemented as camera 204b. Microphones are designated as top microphones TM1-TM4 and front view microphone FVM1, all of which may be integrated with a respective camera 204a. Microphones may alternatively or additionally be designated as HM15-HM45, all of which may be integrated with a respective camera 204b.

Table 1 below lists five exemplary cases where different VR-compatible files may be created.

TABLE 1
Case 1:

| | |
|---|---|
| Name: John Smith | Cart No.: CA1 |
| Guest ID: GH-1203 | Seat No.: SE11 |
| Time: 11:30, 03-Jan-17 | Selected Cameras: TC1 (main), HC11-15 |
| Order: Seat View | Selected Mics: HM15 (main), TM1 |
| Other Guests: No | |

Case 2:

| | |
|---|---|
| Name: Thomas Miller | Cart No.: CA1 |
| Guest ID: KM-7562 | Seat No.: SE13 |
| Time: 11:30, 03-Jan-17 | Selected Cameras: TC3 (main), HC31-35, |
| | TC4 |
| Order: Seat View | Selected Mics: HM35 (main), TM3 |
| Other Guests: No | |

Case 3:

| | |
|---|---|
| Name: John Smith | Cart No.: CA1 |
| Guest ID: GH-1203 | Seat No.: SE11 (main), SE13 |
| Time: 11:30, 03-Jan-17 | Selected Cameras: TC1 (main), TC13 |
| Order: Seat View | Selected Mics: HM15, HM45, TM1 |
| Other Guests: Mike Smith | |
| (PP-9426) | |

Case 4:

| | |
|---|---|
| Name: John Smith | Cart No.: CA1 |
| Guest ID: GH-1203 | Seat No.: SE11 |
| Time: 11:30, 03-Jan-17 | Selected Cameras: FV1, RV1, RSC1, |
| | LSC1 |
| Order: Vehicle View | Selected Mics: HM15 (main), TM1 |
| Other Guests: No | |

Case 5:

| | |
|---|---|
| Name: John Smith | Cart No.: CA1 |
| Guest ID: GH-1203 | Seat No.: SE11, SE12 |
| Time: 11:30, 03-Jan-17 | Selected Cameras: FVC1 |
| Order: Front View | Selected Mics: HM15 (main), FVM1, |
| Other Guests: Emma Smith | HM15, HM25 |
| (TD-3819) | |

Referring to FIG. 6A, in Case 1 a VR-compatible file is created of the rider in seat SE11, identified as John Smith. In Case 1, camera TC1 is selected as the main camera 204a and harness cameras HC11-HC15 may additionally be selected for the VR-compatible file. Further, microphone HM15 is selected as the main microphone and microphone TM1 may be additionally be selected.

Referring to FIG. 6B, in Case 2 a VR-compatible file is created of the rider in seat SE13, identified as Thomas Miller, who is not a member of rider John Smith's party, in which case Thomas Miller may not wish to include any images of John Smith, and John Smith may not wish to appear in any VR-compatible file for Thomas Miller. In Case 2, since cameras 204a include an assembly of cameras aimed in a surrounding 360° angle (including up/down), individual cameras in the assembly can selectively omit images and/or capture, save and transmit images. As shown in FIG. 6B, only images from cameras 204a in selected areas SA13 and SA14 are used to create the VR-compatible file, thereby omitting the rider in seat SE14 while still compiling a file providing a 360° view. Thus in Case 2, camera TC3 is selected as the main camera 204a and camera TC4 is also selected, but not all cameras in the assemblies of TC3 and TC4 are selected, as discussed above. Harness cameras HC31-HC35 may additionally be selected for the VR-compatible file. Further, microphone HM35 is selected as the main microphone and microphone TM3 may be additionally be selected.

Referring to FIG. 6C, in Case 3 a VR-compatible file is created of the rider in seat SE11 (main) and seat 13. In this case the riders in these seats, who did not sit together but are members of the same party, wish to compile a VR-compatible file providing an illusion of the riders as if they were sitting next to each other. In Case 3, since cameras 204a include an assembly of cameras aimed in a surrounding 360° angle (including up/down), individual cameras in the assembly can selectively omit images and/or capture, save and transmit images. As shown in FIG. 6C, only images from cameras 204a in selected areas SA113 and SA111 are used to create the VR-compatible file. Thus in Case 3, camera TC1 is selected as the main camera 204a and camera TC3 is also selected (to capture the rider in seat SE14), but not all cameras in the assemblies of TC3 and TC1 are selected, as discussed above. Microphones HM15 is selected as the main microphone and microphones HM45 and TM1 may be additionally selected.

Referring again to FIG. 6A, unlike the seat view VR-compatible files created in Cases 1-3, in Case 4 a VR-compatible file is created of a vehicle view (i.e., a view outside the vehicle) using cameras FV1, RV1, RSC1 and LSC1. Microphone HM15 is selected as the main microphone and microphone TM1 may be additionally selected. In a case where, for example, the weather is inclement or the ride runs inside, other pre-recorded, or template, video may be used to create the VR-compatible file.

Referring to FIG. 6A, unlike the seat view VR-compatible files created in Cases 1-3 and the vehicle view VR-compatible file created in Case 4, in Case 5 a VR-compatible file is created of a front view (i.e., a view from the front of the vehicle) using cameras FV1, which can also capture the front faces of the riders in seats SE11 and SE12. Microphone HM15 is selected as the main microphone and microphone TM1 may be additionally selected. In a case where, for example, the weather is inclement or the ride runs inside, other pre-recorded, or template, video may be used to create the VR-compatible file.

Table 2 shows a table the computer system 100 uses to create the selected VR-compatible files described in FIG. 5, as well as the sample video in Step S5.

TABLE 2

| Date | Time | Vehicle | Seat | Device | File | Tag (Guest ID) |
|---|---|---|---|---|---|---|
| 3 Jan. 2017 | 11:40 | V1 | SE11 | Top Cam TC1 | Top Video TV1 | GH-1203 |
| 3 Jan. 2017 | 11:40 | V1 | SE11 | Top Mic TM1 | Top Audio HA1 | GH-1203 |
| 3 Jan. 2017 | 11:40 | V1 | SE12 | Top Cam TC2 | Top Video TV2 | TD-3819 |
| 3 Jan. 2017 | 11:40 | V1 | SE12 | Top Mic TM2 | Top Audio HA2 | TD-3819 |
| 3 Jan. 2017 | 11:40 | V1 | SE13 | Top Cam TC3 | Top Video TV3 | KM-7562 |
| 3 Jan. 2017 | 11:40 | V1 | SE13 | Top Mic TM3 | Top Audio HA3 | KM-7562 |
| 3 Jan. 2017 | 11:40 | V1 | SE14 | Top Cam TC4 | Top Video TV4 | PP-9426 |
| 3 Jan. 2017 | 11:40 | V1 | SE14 | Top Mic TM4 | Top Audio HA4 | PP-9426 |
| 3 Jan. 2017 | 11:40 | V1 | SE11 | Harness Cam HC11 | Harness Video HV11 | GH-1203 |
| 3 Jan. 2017 | 11:40 | V1 | SE11 | Harness Cam HC12 | Harness Video HV12 | GH-1203 |
| 3 Jan. 2017 | 11:40 | V1 | SE11 | Harness Cam HC13 | Harness Video HV13 | GH-1203 |
| 3 Jan. 2017 | 11:40 | V1 | SE11 | Harness Cam HC14 | Harness Video HV14 | GH-1203 |
| 3 Jan. 2017 | 11:40 | V1 | SE11 | Harness Cam HC15 | Harness Video HV15 | GH-1203 |
| 3 Jan. 2017 | 11:40 | V1 | SE11 | Haeness Mic HM15 | Harness Audio HA15 | GH-1203 |
| 3 Jan. 2017 | 11:40 | V1 | SE12 | Harness Cam HC21 | Harness Video HV21 | TD-3819 |
| . | . | . | . | . | . | . |
| . | . | . | . | . | . | . |
| . | . | . | . | . | . | . |
| 3 Jan. 2017 | 11:40 | V1 | SE11, SE12 | Line Cam LC11 | Line Video LV11 | GH-1203, TD-3819 |
| 3 Jan. 2017 | 11:40 | V1 | SE11, SE12 | Line Cam LC12 | Line Video LV12 | GH-1203, TD-3819 |
| 3 Jan. 2017 | 11:40 | V1 | SE13, SE14 | Line Cam LC13 | Line Video LV13 | KM-7562, PP-9426 |
| 3 Jan. 2017 | 11:40 | V1 | SE13, SE14 | Line Cam LC14 | Line Video LV14 | KM-7562, PP-9426 |
| 3 Jan. 2017 | 11:40 | V1 | SE11-14 | Front Cam FC1 | Front Video FV1 | GH-1203, TD-3819, KM-7562, PP-9426 |
| 3 Jan. 2017 | 11:40 | V1 | SE11-14 | Rear Cam RC1 | Rear Video RV1 | GH-1203, TD-3819, KM-7562, PP-9426 |
| 3 Jan. 2017 | 11:40 | V1 | SE11-14 | R-Side Cam RSC1 | R-Side Video RSC1 | GH-1203, TD-3819, KM-7562, PP-9426 |
| 3 Jan. 2017 | 11:40 | V1 | SE11-14 | L-Side Cam LSC1 | L-Side Video LSC1 | GH-1203, TD-3819, KM-7562, PP-9426 |
| 3 Jan. 2017 | 11:40 | V1 | SE11, SE12 | Front View Cam FVC1 | Front View Video FVV1 | GH-1203, TD-3819 |
| 3 Jan. 2017 | 11:40 | V1 | SE11, SE12 | Front View Mic FVM1 | Front View Audio FVA1 | GH-1203, TD-3819 |

Although the method of providing a virtual reality souvenir and distribution system has been described with reference to several exemplary embodiments, it is understood that the words that have been used are words of description and illustration, rather than words of limitation. Changes may be made within the purview of the appended claims, as presently stated and as amended, without departing from the scope and spirit of the method of providing a virtual reality souvenir and distribution system in its aspects. Although the method of providing a virtual reality souvenir and distribution system has been described with reference to particular means, materials and embodiments, the method of providing a virtual reality souvenir and distribution system is not intended to be limited to the particulars disclosed; rather the method of providing a virtual reality souvenir and distribution system extends to all functionally equivalent structures, methods, and uses such as are within the scope of the appended claims.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. Such standards are periodically superseded by more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of the disclosure described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Accordingly, the present disclosure provides various systems, servers, methods, media, and programs. Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular materials and embodiments, embodiments of the invention are not intended to be limited to the particulars disclosed; rather the invention extends to all functionally equivalent structures, methods, and uses such as are within the scope of the appended claims.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The preceding description of the disclosed embodiments is provided to enable any person skilled in the art to make or use the present disclosure. As such, the above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While the invention has been described with reference to specific embodiments, those skilled in the art will understand that various changes may be made and equivalents may be substituted for elements thereof without departing from the true spirit and scope of the invention. While exemplary embodiments are described above, it is not intended that these embodiments describe all possible forms of the invention. Rather, the words used in the specification are words of description rather than limitation, and it is understood that various changes may be made without departing from the spirit and scope of the disclosure. In addition, modifications may be made without departing from the essential teachings of the invention. Furthermore, the features of various implementing embodiments may be combined to form further embodiments of the invention.

What is claimed is:

1. A method for distributing a virtual reality souvenir comprising:
acquiring, using a processor of a computer, audio and video data via one or more recording devices;
compiling, using the processor, the acquired audio and video data into a virtual reality file;
acquiring, using the processor, user identifying information corresponding to the acquired audio and video data, wherein the user identifying information includes at least one of user information, attraction information, recording time, and ride seat number;
storing, using the processor, the virtual reality file and the corresponding identifying information into a database;
retrieving, using the processor, the virtual reality file and the corresponding user identifying information from the database; and
transmitting, using the processor, to a user device the retrieved virtual reality file and the corresponding identifying information via at least one of a digital distribution system and a physical souvenir distribution system.

2. The method according to claim 1, wherein the retrieving of the virtual reality file and the corresponding user identifying information is based on a user's identity.

3. The method according to claim 2, wherein the user's identity is based on at least one of the user's identification code, name and biometric data.

4. The method according to claim 3, wherein the biometric data can include the user's fingerprint, eye, face and hand.

5. The method according to claim 1, wherein the acquiring of the user identifying information further comprises at least one of:
a user wearing the one or more recording devices; and
a user holding the one or more recording devices.

6. A system for distributing a virtual reality souvenir comprising:
a plurality of cameras configured to capture a plurality of images;
a plurality of microphones configured to capture a plurality of sounds, wherein the plurality of cameras and plurality of microphones are mounted to an attraction;
a memory configured to store the captured images and sounds;
a compiler configured compile the stored images and sounds into a virtual reality file; and
a transmitter configured to transmit the compiled virtual reality file to an external device.

7. The system according to claim 6, wherein:
at least one camera of the plurality of cameras is configured to capture an image of a user of the attraction, and
at least one microphone of the plurality of cameras is configured to capture a sound of the user.

8. The system according to claim 7, wherein:
the memory is further configured to store identifying information of the user, and the transmitter is further configured to transmit the compiled virtual reality file to the
external device based on the identifying information.

9. The system according to claim 8, wherein the identifying information is captured by at least one camera of the plurality of cameras via at least one of a user's body part and a scannable code.

10. The system according to claim 7, wherein at least another camera of the plurality of cameras is configured to capture an image of another user located adjacent to the user of the attraction.

11. The system according to claim 6, wherein:
the memory is further configured to store identifying information of a user, and
the transmitter is further configured to transmit the compiled virtual reality file to the external device based on the identifying information.

12. The system according to claim 10, further comprising a scanner configured to scan the identifying information, wherein the transmitter is further configured to transmit the compiled virtual reality file to the external device upon scanning of the identifying information.

13. The system according to claim 6, wherein the external device is at least one of a stationary computer, a mobile computer, a personal computer, a laptop computer, a tablet computer, a wireless smartphone, a personal digital assistant, a global positioning satellite device, a virtual reality system, an augmented reality system, and a kiosk.

14. The system according to claim 6, wherein the compiler is further configured to add to the virtual reality file an image of a user who was not captured by a camera of the plurality of cameras.

15. A kiosk for distributing a virtual reality souvenir comprising:
a receiver configured to receive from a database:
a virtual reality file of audio and video images captured at an attraction, and
user identifying information associating a user with the virtual reality file; and
a transmitter configured to transmit the virtual reality file to an external device.

16. The kiosk according to claim 15, further comprising a point-of-sale system configured to accept at least one of electronic and cash payment for the virtual reality file.

17. The kiosk according to claim 15, wherein the transmitter is further configured to wirelessly transmit the virtual reality file to a user device.

18. The kiosk according to claim 15, wherein the transmitter is further configured to write the virtual reality file to a tangible storage medium.

19. The kiosk according to claim 15, further comprising a display configured to display the images of the virtual reality file.

20. A tangible non-transitory computer readable storage medium that stores a computer program, the computer program, when executed by a processor, causing a computer apparatus to perform the method of claim 1.
